(19) United States
(12) Patent Application Publication
(10) Pub. No.: US 2018/0113081 A1
(43) Pub. Date: Apr. 26, 2018

(54) SEMICONDUCTOR INSPECTION METHOD AND MANAGEMENT METHOD OF SEMICONDUCTOR MANUFACTURING APPARATUS

(71) Applicant: Renesas Electronics Corporation, Tokyo (JP)

(72) Inventors: Toru SHINAKI, Ibaraki (JP); Yoshinori KONDO, Ibaraki (JP); Yuji KIKUCHI, Ibaraki (JP)

(21) Appl. No.: 15/704,261

(22) Filed: Sep. 14, 2017

(30) Foreign Application Priority Data
Oct. 26, 2016 (JP) 2016-209270

(51) Int. Cl. G01N 21/956; G01N 21/47; G01N 21/95

(52) U.S. Cl. CPC G01N 21/956; G01N 21/9501; G01N 21/4738

(57) ABSTRACT

A method of increasing the yield of product semiconductor substrates includes the step of: (a) providing a monitor wafer over which a laminated film, which is similar to that over a product wafer and includes a conductor film such as an Al film, is formed; (b) etching the laminated film over the monitor wafer in a state where a photoresist film is not formed over the laminated film; and (c) irradiating the monitor wafer, placed over a stage of a foreign matter inspection apparatus, with laser light such that an etch residue (defect) is detected by its scattered light.

### CROSS-REFERENCE TO RELATED APPLICATIONS

The disclosure of Japanese Patent Application No. 2016-209270 filed on Oct. 26, 2016 including the specification, drawings and abstract is incorporated herein by reference in its entirety.

### BACKGROUND

The present invention relates to a semiconductor inspection method and a management technique of a semiconductor manufacturing apparatus, and relates, for example, to a technique effective when applied to process management for manufacturing a semiconductor device.

In detecting a defect occurring in the process of manufacturing a semiconductor device, how to utilize this defect detection in manufacturing management of a semiconductor device is an important technique.

Therefore, a manufacturing process management method of a semiconductor device is disclosed, for example, in Japanese Unexamined Patent Application Publication No. 2005-191067 (Patent Document 1). In the above Patent Document 1, a method is disclosed in which in in-line inspection, a minute foreign matter is detected by irradiating a metal film formed over a dummy wafer with laser light or the like by a foreign matter inspection apparatus and manufacturing steps are managed based on the detection results.

### RELATED ART DOCUMENT

### Patent Document

[Patent Document 1] Japanese Unexamined Patent Application Publication No. 2005-191067

### SUMMARY

For defect detection in the manufacturing process of a semiconductor device, two inspections are known, including foreign matter inspection using a monitor wafer (an inspection semiconductor substrate) and defect inspection using a product semiconductor wafer (a semiconductor substrate to form a semiconductor chip to be mounted on a product such as a semiconductor device, and hereinafter simply referred to as a product wafer).

In the foreign matter inspection using a monitor wafer, a rotating monitor wafer is irradiated with laser light and a foreign matter is detected by observing the reflected scattered light, and hence there are advantages that the inspection speed is high and high sensitivity is easily kept, but a defect that occurs during being processed cannot be detected.

On the other hand, in the defect inspection using a product wafer, a product wafer actually processed is inspected, and hence a defect that occurs during being processed can be detected, but it takes time for the inspection because it uses pattern comparison. Also, in the defect inspection, when the unevenness of the surface of Al (aluminum) is large, it is necessary to lower the sensitivity of detection because the unevenness may be detected as a defect, and hence high sensitivity cannot be kept.

Other problems and new characteristics will become clear from the description and accompanying drawings of the present specification.

A semiconductor inspection method according to one embodiment includes the steps of: (a) providing an inspection semiconductor substrate over which a laminated film including a conductor film is formed; (b) after the step (a), etching the laminated film over the inspection semiconductor substrate in a state where a photoresist film is not formed over the laminated film; and (c) after the step (b), detecting a defect in the inspection semiconductor substrate.

In addition, a management method of a semiconductor manufacturing apparatus according to one embodiment includes the steps of: (a) providing an inspection semiconductor substrate over which a laminated film including a conductor film is formed; and (b) after the step (a), etching the laminated film over the inspection semiconductor substrate in a state where a photoresist film is not formed over the laminated film. The management method further includes the steps of: (C) after the step (b), detecting a defect in the inspection semiconductor substrate; and (d) after the step (c), obtaining, based on the defect detected in the step (c), a management value for managing a semiconductor manufacturing apparatus in which the defect is generated.

According to the one embodiment, the yield of semiconductor substrates (for products) can be increased.

### BRIEF DESCRIPTION OF THE DRAWINGS

FIG. 1 is a sectional view illustrating one example of the structure of a product semiconductor substrate of an embodiment;

FIG. 2 is a flowchart illustrating one example of an assembly procedure of the semiconductor substrate illustrated in FIG. 1;

FIG. 3 is a flowchart illustrating one example of a processing procedure of Al wiring in the semiconductor substrate illustrated in FIG. 1;

FIG. 4 is a sectional view illustrating one example of the structure of a main part of the semiconductor substrate corresponding to the flow of FIG. 3;

FIG. 5 is a sectional view illustrating one example of the structure of a main part of the semiconductor substrate corresponding to the flow of FIG. 3;

FIG. 6 is a sectional view illustrating the structure of a main part of a semiconductor substrate when a defect has occurred in the etching step in FIG. 3;

FIG. 7 is a data table for comparing foreign matter inspection of the embodiment with foreign matter inspection and defect inspection of comparative examples;

FIG. 8 is a sectional view illustrating one example of the structure of a main part of an inspection semiconductor substrate corresponding to a foreign matter inspection procedure of the embodiment;

FIG. 9 is a partial sectional view illustrating one example of a state occurring when the foreign matter inspection of the embodiment is performed;

FIG. 10 is a partial plan view illustrating one example of an etching residue (hereinafter also referred to as an etch residue) detected in the defect inspection of the comparative example;

FIG. 11 is a partial plan view illustrating one example of an etch residue not detected in the defect inspection of the comparative example;

FIG. 12 is a partial plan view illustrating one example of an etch residue detected in the foreign matter inspection of the embodiment;

FIG. 13 is a graph illustrating a relationship between the total number of defects and minute etch residues that are obtained from the foreign matter inspection of the embodiment;

FIG. 14 is a sectional view illustrating a variation of the structure of the product semiconductor substrate; and

FIG. 15 is an enlarged sectional view illustrating the structure of the A portion in FIG. 14.

### DETAILED DESCRIPTION

In the following embodiments, description of the same or similar parts will not be repeated in principle, unless particularly necessary.

Also, when necessary for convenience in the following embodiments, description is given by dividing an embodiment into a plurality of sections or embodiments; however, unless expressly stated, they are not independent of one another, but one is in a relationship such as a variation, details, supplementary explanation, etc. of part or the whole of the others.

In addition, in the following embodiments, when referred to the number of elements, etc. (number of units, numerical value, quantity, range, etc., are included), unless expressly stated or except when the number is obviously limited to specific numbers in principle, the number is not limited to the specific ones but may be more or less than the specific numbers.

In addition, in the following embodiments, it is needless to say that constituent elements (also including constituent steps, etc.) are not necessarily requisite unless expressly stated or except when they are obviously requisite in principle.

In addition, in the following embodiments, when the shapes and positional relationships, etc., of the constituent elements, etc., are referred to, those substantially approximate or similar to the shapes, etc., should be included, unless expressly stated or except when considered to be clearly otherwise in principle. This also applies to the above numerical values and ranges.

Hereinafter, preferred embodiments of the present invention will be described in detail based on the accompanying views. In each view for explaining the embodiments, components having the same function will be denoted with the same reference numerals, and duplicative description thereof will be omitted. In addition, in order to make the views easier to understand, hatching may be added even in a plan view.

### <Configuration of Semiconductor Substrate>

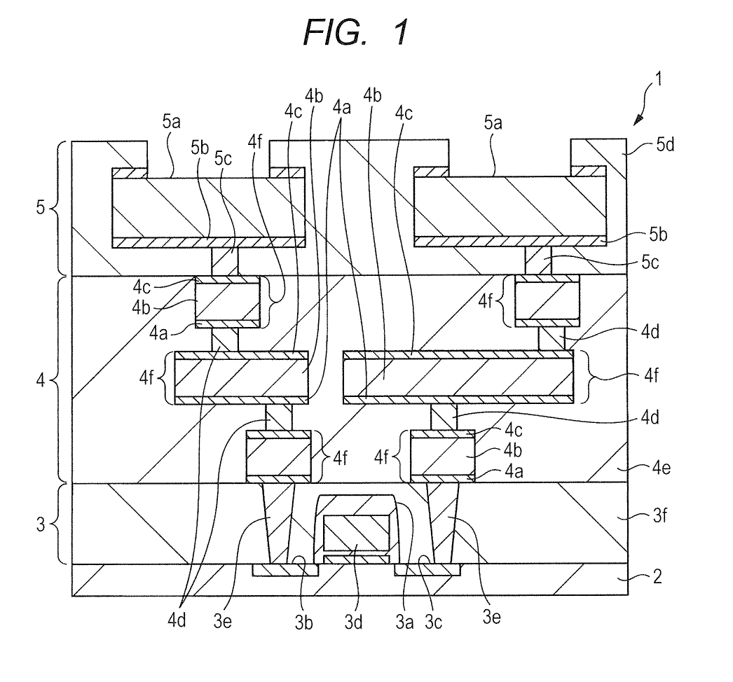

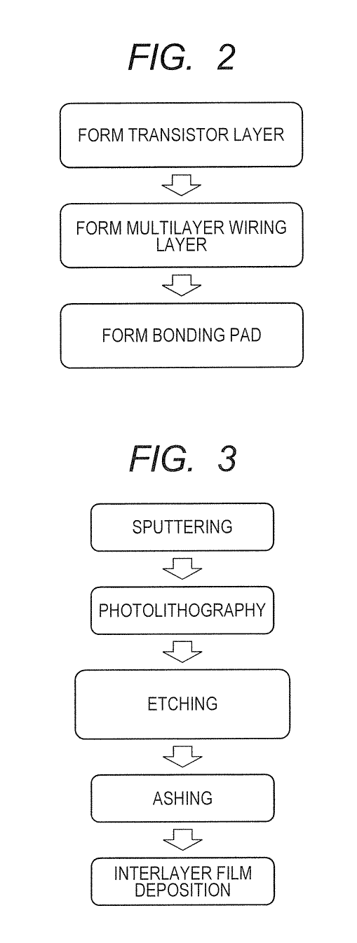

FIG. 1 is a sectional view illustrating one example of the structure of a product semiconductor substrate of an embodiment, and FIG. 2 is a flowchart illustrating one example of an assembly procedure of the semiconductor substrate illustrated in FIG. 1.

A semiconductor substrate 1 of the present embodiment illustrated in FIG. 1 is a product semiconductor substrate (product wafer), in which a multilayer wiring layer 4 is formed over a Si (silicon) substrate 2, and a pad layer 5 is provided over an upper layer of which bonding pads 5a are formed. In this embodiment, the case where a transistor layer 3 is formed over the surface layer of the Si substrate 2 will be described. That is, over the surface layer of the Si substrate 2, the transistor layer 3, the multilayer wiring layer 4 formed over the transistor layer 3, and the pad layer 5 formed over the multilayer wiring layer 4 are formed.

Herein, in the transistor layer 3, a transistor 3a having electrodes of a source 3b, a drain 3c, and a gate 3d is formed to be arranged in an insulating film 3f.

Each of the source 3b and the drain 3c is coupled to a contact part (plug) 3e in which a conductor film is embedded, and is electrically coupled to an upper wiring (laminated film 4f).

In the multilayer wiring layer 4, a plurality of the laminated films 4f each including a conductor film are formed. Details of these laminated films 4f will be described later, but the laminated film 4f of the present embodiment has a three-layer structure, and the case where all of the three layers are conductor films will be described.

In an insulating film 4e, the laminated films 4f formed in the multilayer wiring layer 4 are electrically coupled together in its hierarchical direction (thickness direction of the insulating film 4e) by a contact part 4d in which a conductor film is embedded.

The pad layer 5 is provided with a plurality of the bonding pads 5a that are electrodes exposed to the surface. An underlying metal film 5b is formed in a lower layer of the bonding pad 5a, and the underlying metal film 5b and the laminated film 4f in the multilayer wiring layer 4 are electrically coupled via a contact part 5c in which a conductor film is embedded in an insulating film 5d.

The bonding pad 5a is an electrode to which, for example, a metal wire (not illustrated) or the like is electrically coupled.

The semiconductor substrate 1 is used for forming a product such as, for example, a semiconductor chip for a nonvolatile memory (flash memory as one example) or a SOC (System On a Chip).

In a formation procedure of the semiconductor substrate 1, the transistor layer 3 including the transistor 3a is first formed over the Si substrate 2 (formation of transistor layer), as in the flow illustrated in FIG. 2. Herein, the transistor layer 3 is formed by sequentially forming the transistor 3a, the contact part 3e in the insulating film 3f, and the like.

After the transistor layer is formed, the multilayer wiring layer 4 is formed over the upper layer of the transistor layer 3 (formation of multilayer wiring layer). Herein, the multilayer wiring layer 4 is formed by sequentially forming the laminated film 4f and the insulating film 4e, and the contact part 4d and the insulating film 4e such that they are stacked.

After the multilayer wiring layer 4 is formed, the pad layer 5 is formed thereover. Herein, the contact part 5c and the insulating film 5d, and the bonding pad 5a and the insulating film 5d are sequentially formed (formation of bonding pad).

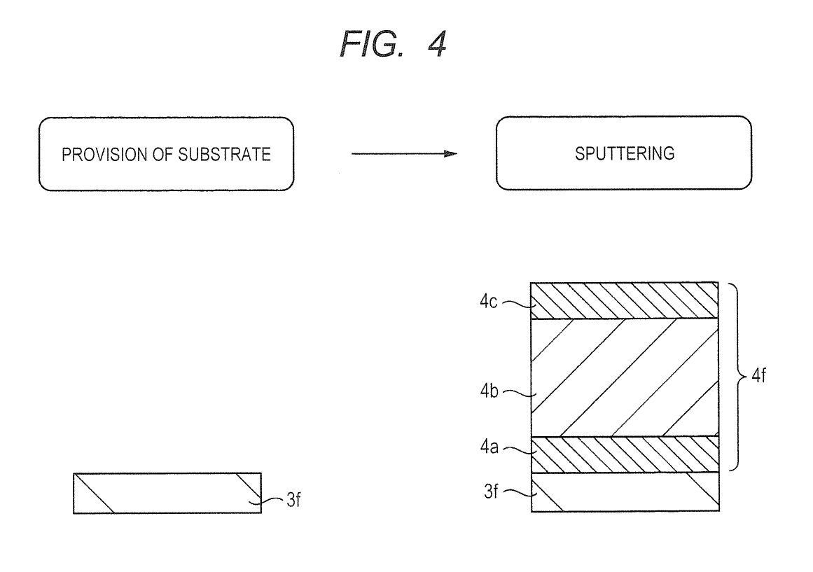

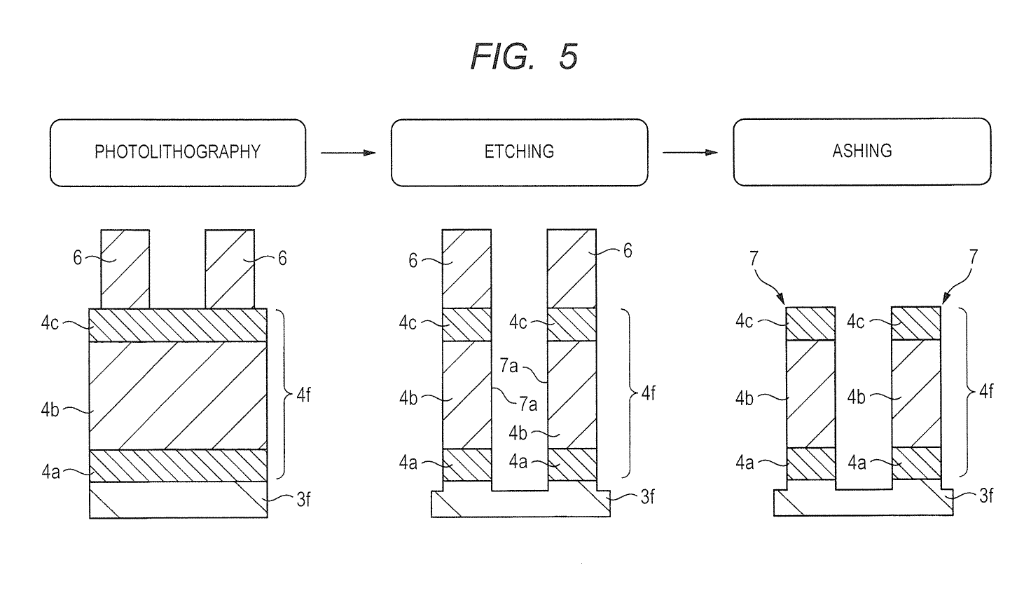

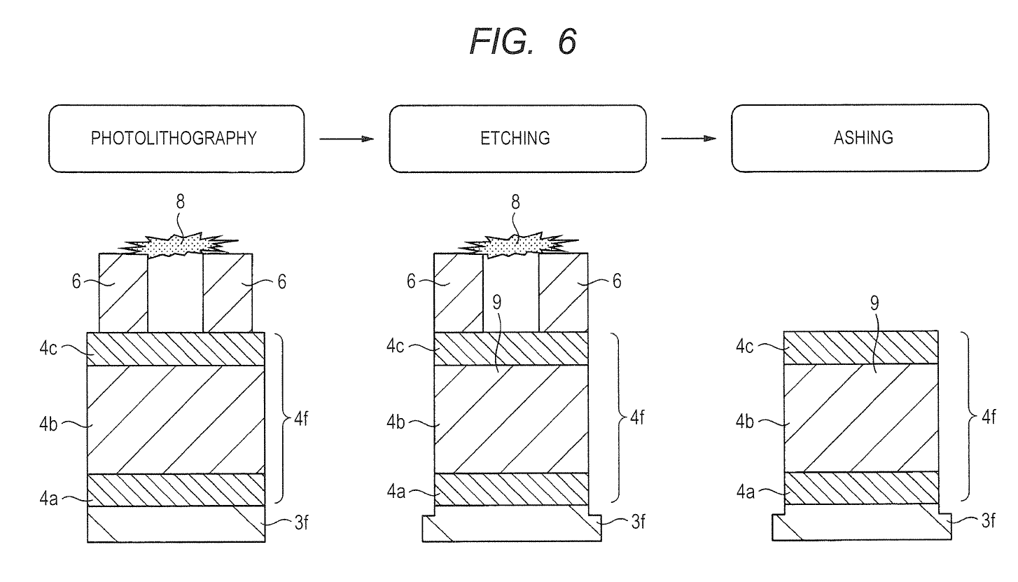

Next, a processing procedure of Al (aluminum) wiring in the multilayer wiring layer 4 in the semiconductor substrate 1 illustrated in FIG. 1 will be described. FIG. 3 is a flowchart illustrating one example of a processing procedure of Al wiring in the semiconductor substrate illustrated in FIG. 1; FIG. 4 is a sectional view illustrating one example of the structure of a main part of the semiconductor substrate corresponding to the flow of FIG. 3; FIG. 5 is a sectional view illustrating one example of the structure of a main part of the semiconductor substrate corresponding to the flow of FIG. 3; and FIG. 6 is a sectional view illustrating the structure of a main part of a semiconductor substrate when a defect has occurred in the etching step in FIG. 3.

First, the substrate illustrated in FIG. 4 is provided. That is, the semiconductor substrate 1, in which the transistor layer 3 including the transistor 3a, the insulating film 3f, and the like illustrated in FIG. 1 is formed, is provided. After the substrate is provided, sputtering illustrated in FIGS. 3 and 4 is performed. That is, a conductor film, which will eventually serve as wiring in the product semiconductor substrate 1, is formed over the transistor layer 3 illustrated in FIG. 1 by the sputtering. In the present embodiment, a case will be described in which the wiring is the laminated film 4f including three conductor films, as illustrated in the sputtering in FIG. 4. Herein, the laminated film 4f includes a lowermost layer 4a, an intermediate layer 4b arranged over the lowermost layer 4a, and an uppermost layer 4c arranged over the intermediate layer 4b. In this case, the lowermost layer 4a includes a TiN film and a Ti film arranged over the TiN film. Further, the intermediate layer 4b is an Al film or an Al alloy film. Furthermore, the uppermost layer 4c includes a TiN film and a Ti film arranged over the TiN film.

As one example, the thickness of the TiN film of the lowermost layer 4a is 50 nm, and that of the Ti film is 5 nm. The thickness of the Al film or the Al alloy film of the intermediate layer 4b is 250 nm, that of the TiN film of the uppermost layer 4c is 20 nm, and that of the Ti film is 15 nm, but the thickness of each film of the laminated film 4f should not be limited to the above numerical value.

After the sputtering, photolithography illustrated in FIGS. 3 and 5 is performed. That is, a photoresist film 6 for forming a wiring pattern 7a for circuit is formed over the laminated film 4f. In detail, the photoresist film 6 for forming the wiring pattern 7a is formed over the laminated film 4f so as to have a desired pattern.

After the photolithography process is performed, etching illustrated in FIGS. 3 and 5 is performed. Herein, the laminated film 4f is etched such that it has the shape of the wiring pattern 7a by using the photoresist film 6 as a mask.

After the etching, ashing illustrated in FIGS. 3 and 5 is performed. Herein, the unnecessary photoresist film 6 is removed by the ashing.

Thereby, wiring 7 including the laminated film 4f is formed. Thereafter, interlayer film deposition illustrated in FIG. 3 is performed.

### <Occurrence of Defect>

FIG. 6 is a sectional view illustrating the structure of a semiconductor substrate when a defect has occurred in the etching step in FIG. 3.

For example, the laminated film 4f is formed over the transistor layer 3 over the Si substrate 2 illustrated in FIG. 1 by the sputtering illustrated in FIG. 4, and after the sputtering, a foreign matter 8 adheres over the photoresist film 6 in a photolithography step in FIG. 6. In the photolithography step, the photoresist film 6 for forming the wiring pattern 7a is originally formed in a desired pattern over the laminated film 4f, as illustrated in the photolithography in FIG. 5.

In the photolithography step illustrated in FIG. 6, however, the foreign matter 8 adheres over the photoresist film 6, and hence a desired pattern for forming the wiring 7 in FIG. 5 cannot be formed properly in the laminated film 4f. And when the etching illustrated in FIG. 6 is performed after the photolithography, proper etching is not performed because the foreign matter 8 serves as a mask, so that an etch residue (defect) 9 occurs. That is, as a result that the etching is performed in a state where the foreign matter 8 serves as a mask, a portion of the area where the etching should be originally performed is left without being etched, which becomes a defect as the etch residue (defect) 9.

After the etching, the photoresist film 6 over the laminated film 4f, which becomes unnecessary, is removed by asking in FIG. 6. At this time, the foreign matter 8 adhering to the photoresist film 6 is also removed together, but there occurs a state in which a desired proper pattern is not formed in the laminated film 4f and the etch residue 9 occurs.

### <Foreign Matter Inspection (Defect Inspection) of Present Embodiment>

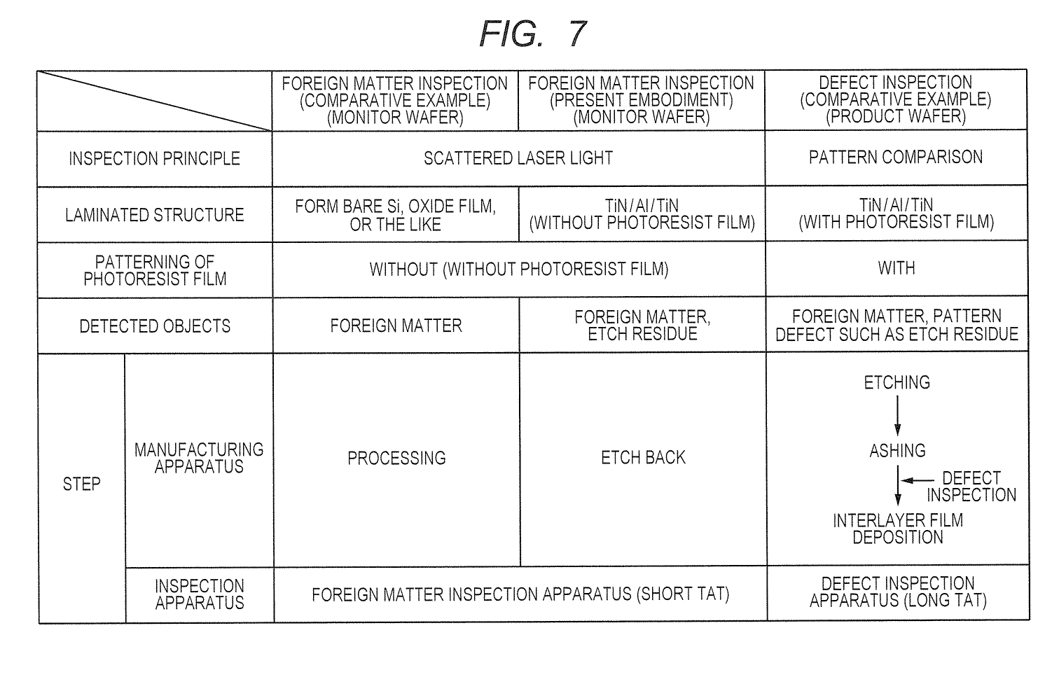

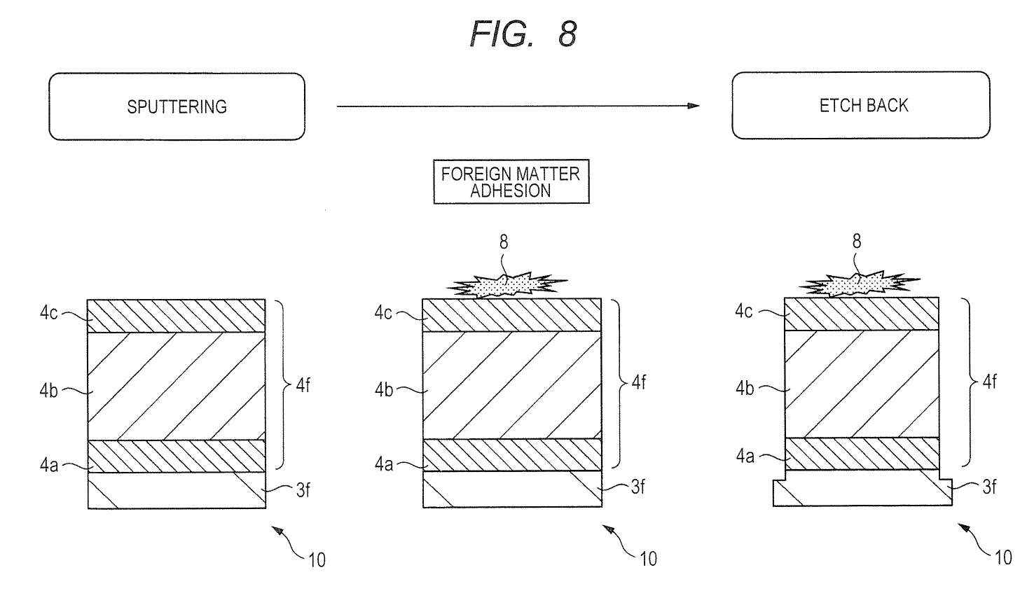

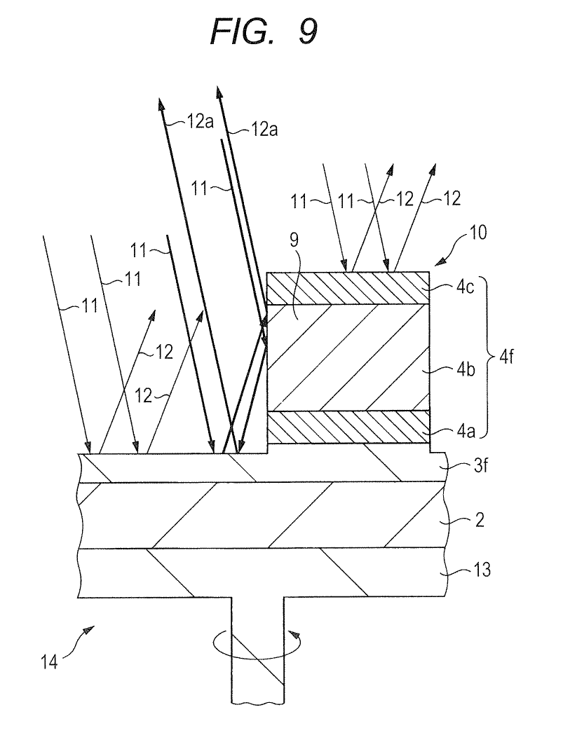

FIG. 7 is a data table for comparing foreign matter inspection of the embodiment with foreign matter inspection and defect inspection of comparative examples; FIG. 8 is a sectional view illustrating one example of the structure of a main part of an inspection semiconductor substrate corresponding to a foreign matter inspection procedure of the embodiment; and FIG. 9 is a partial sectional view illustrating one example of a state occurring when the foreign matter inspection of the embodiment is performed. In FIG. 7, a main film, of the laminated films over the wafer, is only shown in the foreign matter inspection (the embodiment) and the defect inspection (comparative example), and the films other than the main film are omitted.

With reference to FIG. 7, description will be made by comparing with each other the foreign matter inspection of a comparative example the inventors of the present application have comparatively examined, the defect inspection of a comparative example they similarly have comparatively examined, and the foreign matter inspection of the present embodiment.

First, the foreign matter inspection of the comparative example in FIG. 7 will be described in which a monitor wafer, an inspection semiconductor substrate, is used and inspected in a state of bare Si or a state of having an oxide film formed thereover. In this inspection, a foreign matter inspection apparatus is used and inspection is performed without forming a photoresist film over the monitor wafer. The inspection is performed with the foreign matter inspection apparatus, immediately after the monitor wafer is processed by a manufacturing apparatus (e.g., an etching apparatus) to be inspected. In this foreign matter inspection, the surface of the monitor wafer is irradiated with laser light, and a foreign matter is detected by scattering of the reflected light. That is, the detected object is only a foreign matter.

Because the rotating monitor wafer is irradiated with laser light and of the reflected light scattered light reflected by the foreign matter is detected, the inspection speed is so fast that the inspection can be performed in approximately 5 minutes. In addition, because the insulating film formed as an underlayer over the Si substrate has a high degree of flatness, the inspection is less susceptible to the unevenness of the underlying film, thereby allowing high sensitivity to be easily kept. However, there is the problem that a defect occurring when an actual product wafer is processed, such as an etch residue, cannot be detected.

On the other hand, the defect inspection of the comparative example is performed in such a way that a pattern shape engraved in a product wafer is compared with a pattern shape of an adjacent semiconductor chip (or a shot) to extract a difference. Therefore, the structure itself of the laminated film in an actual product wafer (e.g., TiN/Al/TiN or the like) can be adopted as the structure of the laminated film. In addition, the detected object is a foreign matter or a pattern defect such as an etch residue.

That is, in defect inspection using a product wafer, the same semiconductor wafer as that used in the actual processing is inspected, and hence a defect occurring during the processing can be inspected. However, because pattern comparison is performed, there arises the problem that the inspection takes a long time. The inspection takes, for example, approximately 45 minutes. Further, in the defect inspection of the comparative example, the unevenness or the like of the surface of Al, when it is large, may be detected as a defect, and hence it is necessary to lower the sensitivity, whereby there is also the problem that high sensitivity cannot be kept.

Therefore, in the present embodiment, etching is performed by using a monitor wafer (inspection semiconductor substrate) 10 over which the laminated film 4f similar to that over a product wafer, as illustrated in FIG. 8, is formed, and thereafter foreign matter inspection is performed by using a foreign matter inspection apparatus. In the etching, the laminated film 4f is etched without forming the photoresist film 6 as illustrated in FIG. 5 over the laminated film 4f (without forming a pattern). That is, etch back is performed. That is, the etch residue 9 as illustrated in FIG. 9 is detected by performing etch back on the laminated film 4f formed over the monitor wafer (inspection semiconductor substrate) 10, the laminated film 4f being similar to that over a product wafer.

Thereby, it can be detected which step the foreign matter 8 has adhered in.

In this foreign matter inspection, the foreign matter 8 and the etch residue 9 can be detected as detected objects, as illustrated in the foreign matter inspection of the present embodiment in FIG. 7. Further, in the foreign matter inspection of the embodiment, TAT (Turn Around Time) can be shortened because a foreign matter inspection apparatus is used.

Next, a foreign matter inspection method, a semiconductor inspection method of the present embodiment, will be described with reference to FIGS. 8 and 9.

First, a monitor wafer (inspection semiconductor substrate) 10, over which a laminated film 4f including a conductor film is formed, is provided. That is, the laminated film 4f similar to that over a product wafer is formed over the monitor wafer 10 by sputtering. The laminated film 4f similar, for example, to that in the semiconductor substrate 1 that is the product wafer illustrated in FIG. 1 is formed. In the present embodiment, a case will be described in which wiring is the laminated film 4f including three conductor films, as illustrated in the sputtering in FIG. 8. As one example, the laminated film 4f includes a lowermost layer 4a, an intermediate layer 4b arranged over the lowermost layer 4a, and an uppermost layer 4c arranged over the intermediate layer 4b. In this case, the lowermost layer 4a includes a TiN film and a Ti film arranged over the TiN film. Further, the intermediate layer 4b is an Al film or an Al alloy film. Furthermore, the uppermost layer 4c includes a TiN film and a Ti film arranged over the TiN film.

Herein, a case will be described as one example, in which the foreign matter 8 adheres over the laminated film 4f after the laminated film 4f is formed, as illustrated in the adhesion of foreign matter in FIG. 8. After the sputtering, the laminated film 4f over the monitor wafer (inspection semiconductor substrate) 10 is etched in this state, that is, in a state where the photoresist film 6 as illustrated in FIG. 5 is not formed over the laminated film 4f. That is, the etch back illustrated in FIG. 8 is performed.

In the etch back illustrated in FIG. 8, the foreign matter 8 adheres over the laminated film 4f, and hence etching is performed with the foreign matter 8 being used as a mask. That is, etch back is not performed properly, and the etch residue 9 as illustrated in FIG. 9 occurs in the monitor wafer 10. After the etch back, a defect in the monitor wafer 10 where this etch residue 9 has occurred is detected. That is, foreign matter inspection is performed on the monitor wafer 10 by using a foreign matter inspection apparatus.

In the foreign matter inspection of the present embodiment, a detect in the monitor wafer 10, such as the etch residue 9, is detected in the way as illustrated in FIG. 9, in which: the surface of the monitor wafer 10 placed over a stage 13 of a foreign matter inspection apparatus 14 is irradiated with laser light 11; and of reflected light 12 of the laser light 11, scattered light 12a is detected.

In the foreign matter inspecting apparatus 14, of the reflected light 12 of the laser light 11, the reflected light 12 bounced back after hitting a defect such as the etch residue 9 changes its trajectory, and hence this is detected as the scattered light 12a.

In addition, the stage 13 is rotatably installed, so that during the foreign matter inspection, the rotating monitor wafer 10, achieved by rotating the stage 13, can be irradiated with the laser light 11. That is, the surface of the monitor wafer 10 can be irradiated with the laser light 11 from a large number of angles, whereby even a minute defect, such as, for example, the minute etch residue 9 or the foreign matter 8 (see FIG. 8), can be detected without being missed.

It is to be noted that a defect detected in the foreign matter inspection of the present embodiment is the etch residue 9 occurring in the etching illustrated in FIG. 6 in the step of forming (processing) Al wiring illustrated in FIG. 3, in the processing of the semiconductor substrate 1 that is a product wafer. In addition, the etch residue 9 is a defect formed by the foreign matter 8 that had adhered to the photoresist film 6 over the laminated film 4f in a (previous) step before the etching illustrated in FIG. 6. For example, the foreign matter 8 adheres, of the steps of forming (processing) Al wiring illustrated in FIG. 3 for the product semiconductor substrate 1 illustrated in FIG. 1, in the step of the photolithography illustrated in FIG. 6.

According to the foreign matter inspection method that is a semiconductor inspection method of the present embodiment, it can be detected which step, of the steps of forming wiring and the like in a product wafer, the foreign matter 8 has adhered in.

### <Advantages of Semiconductor Inspection Method of Present Embodiment>

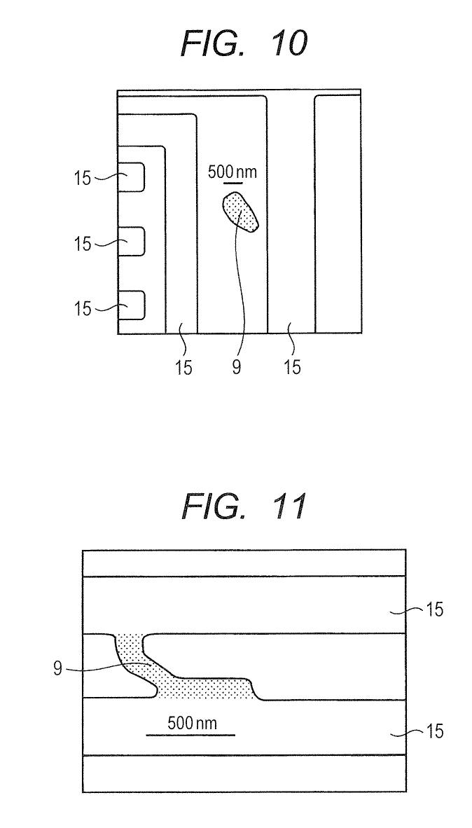

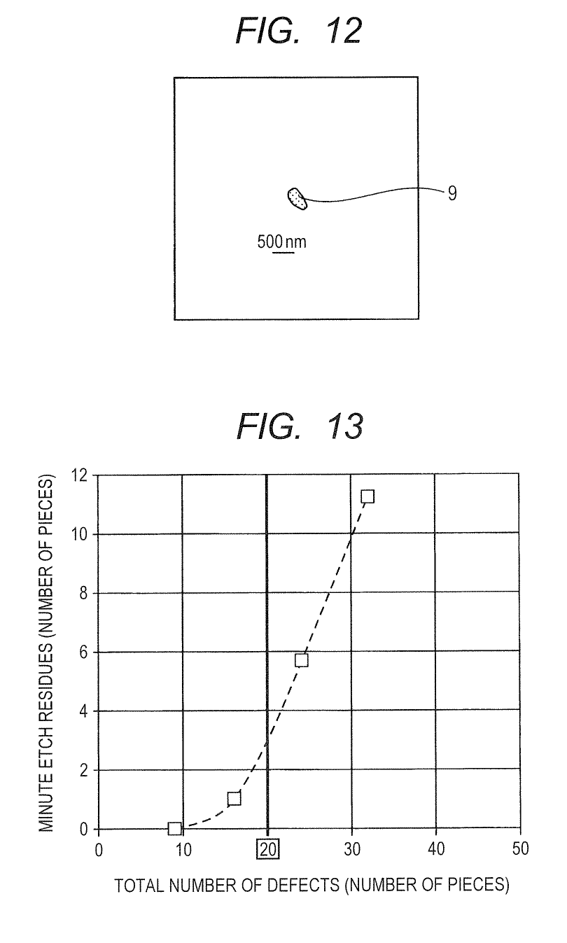

FIG. 10 is a partial plan view illustrating one example of an etch residue detected in the defect inspection of the comparative example; FIG. 11 is a partial plan view illustrating one example of an etch residue not detected in the defect inspection of the comparative example; and FIG. 12 is a partial plan view illustrating one example of an etch residue detected in the foreign matter inspection of the embodiment.

In the semiconductor inspection method of the present embodiment, etch back is performed by using the monitor wafer 10 over which the laminated film 4f similar to that over a product wafer is formed, and hence the etch residue 9, occurring when the etching is performed with the foreign matter 8 that has adhered when the product wafer is processed being used as a mask, can be reproduced.

Further, a defect such as the foreign matter 8 resulting from a reaction product generated during etch back, a defect such as the foreign matter 8 resulting from film peeling from the inner wall of a non-illustrated chamber (processing chamber) of a semiconductor manufacturing apparatus, or the like can be detected.

Because inspection is performed by the foreign matter inspection in which the scattered light 12a is detected with the foreign matter inspection apparatus 14, the inspection can be performed with high sensitivity (approximately 0.3 μm) and in a short TAT (Turn Around Time).

Therefore, it can be detected which step, of the steps of forming wiring and the like in a product wafer, the foreign matter 8 has adhered in, as described above.

Herein, FIG. 10 illustrates the large etch residue 9 that: is detected in the defect inspection of the comparative example; occurs between two wirings 15; and has a length of approximately 500 nm or more. That is, the etch residue 9 illustrated in FIG. 10 is one that can be actually detected in the stage of processing a product wafer.

In the defect inspection of the comparative example, a defect is detected by comparing patterns between adjacent semiconductor chips, whereby the etch residue 9 illustrated in FIG. 10 is detected in this case because the etch residue 9 as illustrated in FIG. 10 does not adhere to the adjacent semiconductor chip.

Further, FIG. 11 illustrates the etch residue 9 that could not be detected in the defect inspection of the comparative example, the etch residue 9 becoming a defect that has not been detected in the stage of processing a product wafer but is detected in a defect analysis step that is a subsequent step. The length of the etch residue 9 illustrated in FIG. 11 is also approximately 500 nm.

In detail, the etch residue 9 illustrated in FIG. 11 is formed so as to straddle the two wirings 15, which leaves the two wirings 15 short-circuited. The etch residue 9 is, for example, a metal residue of a barrier metal between Al wirings. As described above, a metal residue resulting from the etch residue 9 becomes a defect because it cannot be detected in the stage of processing a product wafer, and is discovered as a defect when electrical inspection is performed in a subsequent wafer test (defect analysis test).

In this case, the yield of product wafers decreases.

With respect to the above two comparative examples, the etch residue 9 illustrated in FIG. 12 is one detected by the foreign matter inspection using the semiconductor inspection method of the present embodiment. That is, it is the etch residue 9 detected by the foreign matter inspection using the foreign matter inspection apparatus 14 performed after the etch back that has been performed on the monitor wafer 10 over which the laminated film 4f similar to that over a product wafer is formed. The size of the etch residue 9 illustrated in FIG. 12 is approximately 500 nm or slightly smaller.

In the semiconductor inspection method of the present embodiment, the etch residue 9, the size of which is equal to or smaller than the minute etch residue 9 that cannot be detected in the manufacturing line of product wafers and is found in a defect analysis step, can be detected, as described above. Thereby, the minute etch residue 9, which cannot be detected by the foreign matter inspection and the defect inspection of the comparative examples, can be detected.

As a result, the yield of the semiconductor substrates 1 that become products (product wafers) can be increased.

### <Management Method of Semiconductor Manufacturing Apparatus>

In the foreign matter inspection of the present embodiment after the etch back, the minute etch residue (defect) 9, the size of which is equal to or smaller than the minute etch residue 9 that cannot be detected in the manufacturing line of product wafers and is found in a defect analysis step, can be detected, as described above. Then, based on the detected defect, a management value for managing a semiconductor manufacturing apparatus, in which the minute etch residue (defect) 9 that cannot be detected in the foreign matter inspection and the defect inspection of the comparative examples is generated, is obtained for the etch residue 9, so that the state of the semiconductor manufacturing apparatus can be managed based on the management value.

Herein, FIG. 13 is a graph illustrating a relationship between the total number of defects and minute etch residues that are obtained from the foreign matter inspection of the embodiment on a product wafer. That is, in this graph, the relationship between the total number of defects per semiconductor substrate and the number of the minute etch residues 9 included in this total number of defects is obtained. The defects and etch residues are detected by the foreign matter inspection of the embodiment on a product wafer. The total number of defects is the total number of the defects detected per semiconductor substrate (wafer).

The above management value is a numerical value calculated from the rate of the increase in the total number of defects.

Specifically, according to FIG. 13, the number of the minute etch residues 9 rapidly increases from near the point where the total number of defects exceeds 20 pieces/wafer. That is, the slope of the graph becomes sharp near the point where the total number of defects is 20 pieces/wafer, so that the total number of defects of 20 pieces/wafer is set as the management value.

When the management value is set, for example, to 20 pieces/wafer in the foreign matter inspection after the etch back that is the semiconductor inspection method of the present embodiment, a semiconductor manufacturing apparatus (e.g., an etching apparatus) in which a defect is generated is stopped in a stage where the total number of defects/wafer reaches 20 pieces in order to check the state of the semiconductor manufacturing apparatus, whereby maintenance or repair is performed.

The yield of the semiconductor substrates 1 that are product wafers can be increased by managing a semiconductor manufacturing apparatus, in which a defect is generated, with the use of a management value, as described above. The risk of a decrease in the yield of product wafers can be controlled by setting a management value particularly for a metal residue of a barrier metal that is difficult to be detected in a product wafer.

### <Variation>

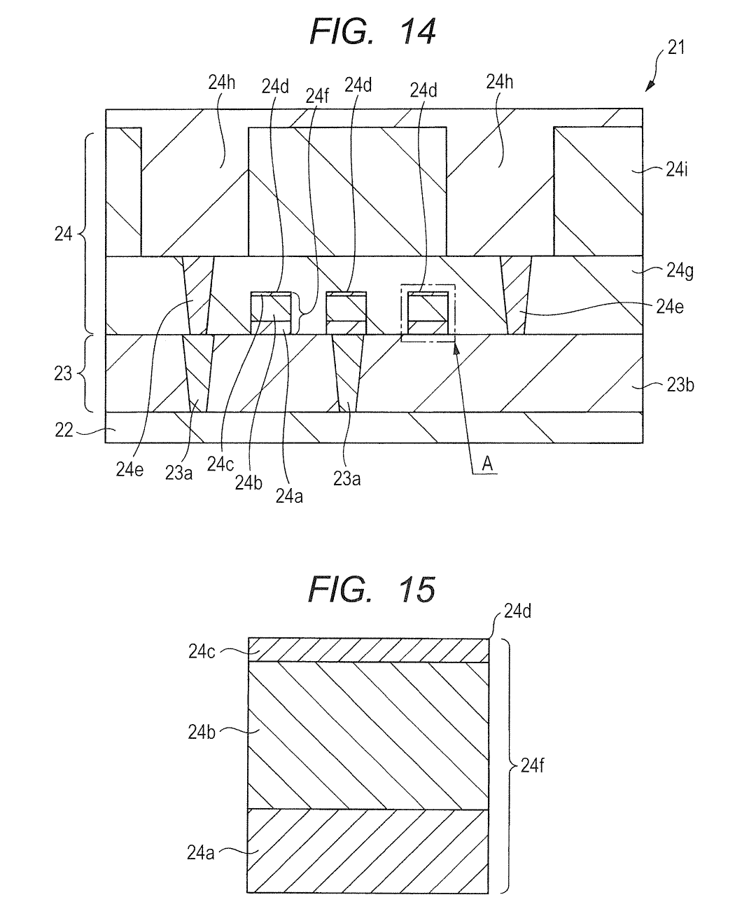

FIG. 14 is a sectional view illustrating a variation of the structure of the product semiconductor substrate; and FIG. 15 is an enlarged sectional view illustrating the structure of the A portion in FIG. 14.

A semiconductor substrate 21 of a variation, illustrated in FIG. 14, is a product semiconductor wafer (product wafer), and herein the case where a DRAM (Dynamic Random Access Memory) is formed will be described. In the semiconductor substrate 21, a transistor layer 23 is formed over a Si substrate 22, a DRAM layer 24 is further formed over the transistor layer 23, and a non-illustrated multilayer wiring layer is furthermore formed over the DRAM layer 24.

That is, the DRAM layer 24 is formed between the transistor layer 23 and the multilayer wiring layer in the DRAM, and a laminated film 24f including a conductor film is provided in the DRAM layer 24. The wiring including the laminated film 24f is a bit line 24d.

In detail, a non-illustrated transistor and a contact part (plug) 23a in which a conductor film is embedded in the insulating film 23b are provided in the transistor layer 23. Further, in the DRAM layer 24 arranged over the transistor layer 23, a plurality of the bit lines 24d, each of which includes the laminated film 24f and is electrically coupled to the contact part 23a, and a contact part (plug) 24e in which a conductor film is embedded in an insulating film 24g are provided. In the DRAM layer 24, a capacitor 24h having a cylinder type cell structure, which is electrically coupled to the contact part 24e and is embedded in an insulating film 24i, is further formed. Herein, the detailed structure of the capacitor 24h is omitted.

The laminated film 24f serving as the bit line 24d includes a lowermost layer 24a, an intermediate layer 24b arranged over the lowermost layer 24a, and an uppermost layer 24c arranged over the intermediate layer 24b, as illustrated in FIG. 15. In this case, the lowermost layer 24a includes a TiN film and a Ti film arranged over the TiN film. The intermediate layer 24b is a W (tungsten) film. The uppermost layer 24c is an SiO film (oxide film).

Also in the semiconductor substrate 21 that is a product wafer over which such a laminated film 24f is formed, etching back is performed on a monitor wafer over which a similar laminated film 24f is formed, and thereafter, foreign matter inspection with the use of the foreign matter inspection apparatus 14 illustrated in FIG. 9 is performed. Accordingly, the etch residue 9, occurring when etching is performed with the foreign matter 8 in FIG. 6 that has adhered when the product wafer is processed being used as a mask, can be reproduced.

Therefore, also for the laminated film 24f of the present variation, it can be detected which step, of the steps of forming wiring and the like in a product wafer, the foreign matter 8 has adhered in, similarly to the above embodiment.

Also in the present variation, inspection is performed by the foreign matter inspection in which the scattered light 12a is detected with the foreign matter inspection apparatus 14, as illustrated in FIG. 9, and hence the inspection can be performed with high sensitivity (approximately 0.3 μm) and in a short TAT (Turn Around Time).

Also in the present variation, the etch residue 9, the size of which is equal to or smaller than the minute etch residue 9 as illustrated in FIG. 12 that cannot be detected in the production line of product wafers but is founded in a defect analysis step, can be detected, similarly to the above embodiment. Thereby, the minute etch residue 9, which cannot be detected in the foreign matter inspection and the defect inspection of the comparative examples illustrated in FIG. 7, can be detected.

As a result, the yield of the semiconductor substrates 21 that are product wafers can be increased.

The invention made by the present inventors has been specifically described based on preferred embodiments; however, the invention should not be limited to the aforementioned embodiments, and it is needless to say that the invention may be modified variously within a range not departing from the gist thereof.

In the above embodiment, a case has been described in which in the foreign matter inspecting apparatus 14, the monitor wafer 10 is irradiated with the laser light 11 from a large number of angles by rotating the stage 13; but it maybe irradiated with the laser light 11 from a large number of directions by fixing the stage 13. That is, an irradiation part for irradiating with the laser light 11 may be provided rotatably.

In the above embodiment and variation, a case has been described in which a main conductor film of each of the laminated films 4f and 24f forming wiring includes Al or an Al alloy; but the main conductor film may include Cu (copper), a Cu alloy, or the like.

What is claimed is:

1. A semiconductor inspection method comprising the steps of:
(a) providing an inspection semiconductor substrate over which a laminated film including a conductor film is formed;
(b) after the step (a), etching the laminated film over the inspection semiconductor substrate in a state where a photoresist film is not formed over the laminated film; and
(c) after the step (b), detecting a defect in the inspection semiconductor substrate.

2. The semiconductor inspection method according to claim 1,
wherein the laminated film includes a lowermost layer, an intermediate layer arranged over the lowermost layer, and an uppermost layer arranged over the intermediate layer,
wherein the lowermost layer includes a TiN film and a Ti film arranged over the TiN film,
wherein the intermediate layer is an Al film or an Al alloy film, and
wherein the uppermost layer includes a TiN film and a Ti film arranged over the TiN film.

3. The semiconductor inspection method according to claim 1,
wherein the defect detected in the step (c) is an etching residue occurring in the etching in the step of forming wiring.

4. The semiconductor inspection method according to claim 3,
wherein the etching residue is a defect formed by a foreign matter that has adhered over the laminated film in a step before the step (b).

5. The semiconductor inspection method according to claim 1,
wherein in the step (c), a surface of the inspection semiconductor substrate is irradiated with laser light such that the defect is detected by scattered light of the laser light.

6. The semiconductor inspection method according to claim 1,
wherein in the step (c), the defect is detected by using a foreign matter inspection apparatus.

7. The semiconductor inspection method according to claim 1,
wherein the laminated film includes a lowermost layer, an intermediate layer arranged over the lowermost layer, and an uppermost layer arranged over the intermediate layer,
wherein the lowermost layer includes a TiN film and a Ti film arranged over the TiN film,
wherein the intermediate layer is a W film, and
wherein the uppermost layer is an oxide film.

8. A management method of a semiconductor manufacturing apparatus comprising the steps of:
(a) providing an inspection semiconductor substrate over which a laminated film including a conductor film is formed;
(b) after the step (a), etching the laminated film over the inspection semiconductor substrate in a state where a photoresist film is not formed over the laminated film;
(c) after the step (b), detecting a defect in the inspection semiconductor substrate; and
(d) after the step (c), obtaining a management value for managing, based on the defect detected in the step (c), a semiconductor manufacturing apparatus in which the defect is generated, and
wherein a state of the semiconductor manufacturing apparatus is managed based on the management value.

9. The manufacturing method of a semiconductor manufacturing apparatus according to claim 8,
wherein the management value is a numerical value calculated from a rate of an increase in the total number of defects obtained by counting the number of etching residues included in the total number of defects detected per semiconductor substrate.

10. The manufacturing method of a semiconductor manufacturing apparatus according to claim 8,
wherein the laminated film includes a lowermost layer, an intermediate layer arranged over the lowermost layer, and an uppermost layer arranged over the intermediate layer,
wherein the lowermost layer includes a TiN film and a Ti film arranged over the TiN film,
wherein the intermediate layer is an Al film or an Al alloy film, and
wherein the uppermost layer includes a TiN film and a Ti film arranged over the TiN film.

11. The manufacturing method of a semiconductor manufacturing apparatus according to claim 8,
wherein in the step (c), a surface of the inspection semiconductor substrate is irradiated with laser light such that the defect is detected by scattered light of the laser light.

12. The manufacturing method of a semiconductor manufacturing apparatus according to claim 8,
wherein in the step (c), the defect is detected by using a foreign matter inspection apparatus.
